(19) United States
(12) Patent Application Publication
(10) Pub. No.: US 2009/0314761 A1
(43) Pub. Date: Dec. 24, 2009

(54) METHOD FOR MANUFACTURING GLOW PLUG AND GLOW PLUG

(75) Inventors: Shuei Ishii, Mie (JP); Yuki Okumura, Aichi (JP)

Correspondence Address: SUGHRUE-265550, 2100 PENNSYLVANIA AVE. NW, WASHINGTON, DC, 20037-3213, US

(73) Assignee: NGK SPARK PLUG CO., LTD., Nagoya-shi (JP)

(21) Appl. No.: 11/915,932

(22) PCT Filed: Mar. 12, 2007
(86) PCT No.: PCT/JP2007/054856

§ 371 Date: Nov. 29, 2007

(51) Int. Cl. F23Q 7/00; H01C 17/02; F02P 19/02

(52) U.S. Cl. 219/270; 29/611; 123/145 A

(57) ABSTRACT

A first center pole (8) is prepared in which an inserting portion (8c) capable of being inserted into an insertion receiving portion (5b) of a heating coil (5) has been formed at its distal end. In a first step, the inserting portion 8c of the first center pole (8) is inserted into the insertion receiving portion (5b) of the heating coil (5) to form an overlapping portion (10a), thereby obtaining a first glow plug intermediate body (10). Then, in a second step, as a current is applied across electrodes (81) and (82) while sandwiching the overlapping portion (10a) by the electrodes (81) and (82), the inserting portion (8c) of the first center pole (8) and the insertion receiving portion (5b) of the heating coil (5) are welded together so as to form a weld portion (10b). At this juncture, the weld portion (10b) is formed such that a ½ turn or more of winding of the heating coil (5) in a state of being not welded to the inserting portion (8c) of the first center pole (8) is present between a distal end position C1 of the weld portion (10b) and a distal end position A1 of the overlapping portion (10a).

### TECHNICAL FIELD

The present invention relates to a method for manufacturing a glow plug and a glow plug manufactured by this manufacturing method.

### BACKGROUND ART

A glow plug described in patent document 1 is conventionally known. As shown in FIG. 5, this glow plug 100 is comprised of a cylindrical metal shell 3 extending in the direction of an axis O; a heating tube 4 which has a cylindrical shape extending in the direction of the axis O, has its distal end 4a closed, and is fixed within the metal shell 3 with its distal end 4a projecting from a distal end of the metal shell 3; a center pole 6 which has a rod shape extending in the direction of the axis O, with its distal end located within the heating tube 4 and its rear end projecting from a rear end of the metal shell 3; and a heating coil 5 which has a helical shape extending in the direction of the axis O, with its distal end 5a joined to the distal end 4a of the heating tube 4 within the heating tube 4 and its rear end joined to the distal end of the center pole 6. In this glow plug, the center pole 6 consists of a first center pole 8 and a second center pole 9 having its distal end 9a joined to a rear end 8b of this first center pole 8.

According to the aforementioned publication, this glow plug 100 is manufactured as follows. Namely, as a first step, as shown in FIG. 6, an inserting portion 8a formed at the distal end of the first center pole 8 is first inserted into an insertion receiving portion 5b which is formed at the rear end of the heating coil 5 to thereby provide an overlapping portion 90a where the inserting portion 8a of the first center pole 8 and the insertion receiving portion 5b of the heating coil 5 abut against each other and overlap in the radial direction. As a result, a first glow plug intermediate body 90 is obtained.

Then, as a second step, the overlapping portion 90a is sandwiched by two electrodes 81 and 82 in the radial direction. The both electrodes 81 and 82 are connected to a power supply 80 by means of a switch S80. The switch S80 is then turned on to apply a current across the both electrodes 81 and 82. The insertion receiving portion 5b of the heating coil 5 and the inserting portion 8a of the first center pole 8 are hence welded to form a weld portion 90b to thereby obtain a second glow plug intermediate body 91.

As shown in FIG. 5, this second glow plug intermediate body 91 is assembled to the metal shell 3 and the like so as to be formed into a glow plug.

At this juncture, the cylindrical heating tube 4 whose both ends are open is first prepared, and the distal end 5a of the heating coil 5 of the second glow plug intermediate body 91 is inserted into this heating tube 4. Then, the heating tube 4 and the distal end 5a of the heating coil 5 are spot welded in this state, and the distal end 4a of the heating tube 4 is closed. Subsequently, an insulating material 7 such as a magnesium powder is sealed in the heating tube 4, and a sealant E such as fluoro rubber or silicon rubber is inserted between a rear end 4b of the heating tube 4 and the first center pole 8, and an outer periphery of the heating tube 4 is subjected to swaging. A sheathed heater 2 is thereby obtained.

Then, the distal end 9a of the second center pole 9 is welded to the rear end 8b of the first center pole 8 to thereby form the center pole 6. Subsequently, the sheathed heater 2 is inserted into the cylindrical metal shell 3, and the sheathed heater 2 is fixed in the metal shell 3 in a state in which the distal end 4a of the heating tube 4 projects on the distal end side of the metal shell 3. An O-ring 16, an insulating bush 14, and a nut 15 are then provided on the second center pole 9 of the center pole 6 projecting from the rear end of the metal shell 3, and the second center pole 9 is fixed to the metal shell 3 in an insulated state. The glow plug thus obtained is used in a diesel engine. [Patent Document 1] FIG. 4 of JP-A-4-15408

### DISCLOSURE OF THE INVENTION

[Problem that the Invention is to Solve]

Incidentally, recent glow plugs tend to be made smaller in diameter in order to increase the temperature rise speed or reduce the diameter of a glow hole due to the demand for more compact and lightweight diesel engines. For this reason, in recent glow plugs, the heating tube 4 with the center pole and the heating coil 5 accommodated therein has its cross-sectional area reduction rate set to be greater than a conventional level, and a processing load acting on the weld portion 90b is also greater than before.

For this reason, if an attempt is made to increase the welding strength between the inserting portion 8a of the first center pole 8 and the insertion receiving portion 5b of the heating coil 5, in the above-described conventional method for manufacturing a glow plug, the trouble of the axis of the heating coil 5 becoming bent at the distal end side rather than at the weld portion 90b, as shown in FIG. 7, has likely occurred.

Then, in the case where the second glow plug intermediate body 91 in which such a trouble has occurred is assembled to the metal shell 3 and the like to form the glow plug, the heating coil 5 is likely to come into contact with the inner cylindrical surface of the heating tube 4, possibly resulting in a defect in quality such as a short-circuit fault and variations in performance when applying current.

The invention has been devised in view of the above-described conventional circumstances, and the problem to be solved is to provide a method for manufacturing a glow plug which is capable of suppressing a defect in quality such as a short-circuit fault and variations in performance when applying current.

### [Means for Solving the Problems]

The present inventors conducted various investigations into causes of defects in quality such as a short-circuit fault and variations in performance when applying current in the conventional manufacturing method. Then, the present inventors clarified the causes as described below, and came to complete the invention.

Namely, one of the causes lies in that, in the conventional manufacturing method, if a current applied across the electrodes 81 and 82 is increased to enhance the welding strength, the amount of weld penetration of the heating coil 5 inevitably increases, with the result that the deformation of the heating coil 5 unfavorably becomes large at the distal end position C of the weld portion 90b.

In addition, another cause lies in that, in the conventional manufacturing method, the weld portion 90b is formed such that the distal end position A of the overlapping portion 90a substantially coincides with the distal end position C of the weld portion 90b. In other words, in the conventional manufacturing method, the electrodes 81 and 82 are disposed such that the distal end position A of the overlapping portion 90a substantially coincides with the distal end face B of each of the electrodes 81 and 82.

A method for manufacturing a glow plug in accordance with a first aspect of the invention thus completed is a method for manufacturing a glow plug including a cylindrical metal shell extending in an axial direction, a heating tube which has a cylindrical shape extending in the axial direction, has its distal end closed, and is fixed within the metal shell with its distal end projecting from a distal end of the metal shell, a center pole which has a rod shape extending in the axial direction, with its distal end located within the heating tube and its rear end projecting from a rear end of the metal shell, and a heating coil which has a helical shape extending in the axial direction, with its distal end joined to the distal end of the heating tube within the heating tube and its rear end joined to the distal end of the center pole, comprising:

a first step of inserting an inserting portion formed at the distal end of the center pole into an insertion receiving portion formed at a rear end of the heating coil, to thereby provide an overlapping portion where the inserting portion and the insertion receiving portion abut against each other and overlap in a radial direction; and

a second step of applying a current across a plurality of electrodes while sandwiching at least a portion of the overlapping portion by the electrodes in the radial direction to thereby weld the inserting portion and the insertion receiving portion so as to form a weld portion,

wherein the weld portion is formed such that a ½ turn or more of winding of the heating coil in a state of being not welded to the inserting portion is present between a distal end position of the weld portion and a distal end position of the overlapping portion.

In addition, a method for manufacturing a glow plug in accordance with a second aspect of the invention is a method for manufacturing a glow plug including a cylindrical metal shell extending in an axial direction, a heating tube which has a cylindrical shape extending in the axial direction, has its distal end closed, and is fixed within the metal shell with its distal end projecting from a distal end of the metal shell, a center pole which has a rod shape extending in the axial direction, with its distal end located within the heating tube and its rear end projecting from a rear end of the metal shell, and a heating coil which has a helical shape extending in the axial direction, with its distal end joined to the distal end of the heating tube within the heating tube and its rear end joined to the distal end of the center pole, comprising:

a first step of inserting an inserting portion formed at the distal end of the center pole into an insertion receiving portion formed at a rear end of the heating coil, to thereby provide an overlapping portion where the inserting portion and the insertion receiving portion abut against each other and overlap in a radial direction; and

a second step of applying a current across a plurality of electrodes while sandwiching the overlapping portion by the electrodes in the radial direction to thereby weld the inserting portion and the insertion receiving portion so as to form a weld portion,

wherein the electrodes are disposed such that a ½ turn or more of winding of the heating coil is present between a distal end face of each of the electrodes and a distal end position of the overlapping portion.

In the manufacturing method in accordance with the first aspect of the invention, the overlapping portion and the weld portion are specified in the first and second steps. Then, a turn or more of winding of the heating coil in a state of being not welded to the inserting portion is caused to be present between the distal end position of the weld portion and the distal end position of the overlapping portion.

In the manufacturing method in accordance with the second aspect of the invention, the electrodes and the overlapping portion are specified in the first and second steps. Then, a ½ turn or more of winding of the heating coil is caused to be present between the distal end face of each of the electrodes and the distal end position of the overlapping portion.

In the case of the second glow plug intermediate body obtained by the manufacturing method in accordance with the first and second aspects of the invention, even if the deformation of the heating coil becomes large at the distal end position of the weld portion, since the heating coil, which is not welded and has a ½ turn or more of winding from the distal end position of the weld portion, is supported by the inserting portion of the center pole, the axis of the heating coil is prevented from becoming bent on the distal end side located forwardly of the distal end position of the weld portion.

For this reason, in the case of the glow plug obtained by this second glow plug intermediate body, even if the current applied across the electrodes is increased to enhance the welding strength between the inserting portion of the center pole and the insertion receiving portion of the heating coil to thereby increase the amount of weld penetration of the heating coil, the heating coil is difficult to come into contact with the inner cylindrical surface of the heating tube. Hence, a defect in quality such as a short-circuit fault and variations in performance when applying current is made difficult to occur.

Therefore, according to the method for manufacturing the glow plug in accordance with the first and second aspects of the invention, it is possible to suppress a defect in quality such as a short-circuit fault and variations in the performance when applying current.

For this reason, the glow plug which is obtained by the manufacturing method in accordance with the first and second aspects of the invention can be made smaller in diameter, so that it is possible to increase the temperature rise speed and cope with a reduction in the diameter of the glow hole due to the demand for a more compact and lightweight diesel engine.

It should be noted that the manufacturing method in accordance with the first aspect of the invention is a method for manufacturing such that the overlapping portion and the weld portion satisfy the above-described positional relationship, and the plurality of electrodes which are disposed around the overlapping portion at the time of forming the weld portion are not defined. In other words, this is a method for manufacturing such that, in manufacturing the second glow plug intermediate body, the weld portion where the inserting portion of the center pole and the insertion receiving portion of the heating coil are welded together is formed, and a nonwelded portion where the insertion receiving portion of the heating coil is only engaged with the inserting portion of the center pole is formed on the distal end side located forwardly of the formed weld portion, thereby allowing the center pole to axially support the heating coil from inside.

Thus, it is sufficient if the electrodes of a welding machine at the time of manufacturing the second glow plug intermediate body are disposed as shown in the manufacturing method in accordance with the second aspect of the invention. If the second glow plug intermediate body is manufactured by disposing the electrodes in this manner, the weld portion is formed such that a ½ turn or more of winding of the heating coil in a state of being not welded to the inserting portion is present between the distal end position of the weld portion and the distal end position of the overlapping portion. It can be said that the first manufacturing method is a manufacturing method which places emphasis on the completion accuracy of the second glow plug intermediate body, whereas the manufacturing method in accordance with the second aspect of the invention is a manufacturing method which places emphasis on the operating efficiency.

In the method for manufacturing a glow plug in accordance with the first aspect of the invention, the weld portion is preferably formed such that three or more turns of winding of the heating coil in a state of being not welded to the inserting portion are not present between the distal end position of the weld portion and the distal end position of the overlapping portion.

In addition, in the method for manufacturing a glow plug in accordance with the second aspect of the invention, the electrodes are preferably disposed such that three or more turns of winding of the heating coil are not present between the distal end face of each of the electrodes and the distal end position of the overlapping portion.

In these cases, the advantages of the invention can be offered without making the nonwelded portion in the inserting portion of the center pole inordinately long. If the nonwelded portion in the inserting portion of the center pole is made inordinately long, the resistance value is likely to vary, variations in the performance when applying current become large, so that it is not favorable.

In the method for manufacturing a glow plug in accordance with the first and second aspects of the invention, the outside diameter of the inserting portion in the overlapping portion is preferably larger than the inside diameter of the insertion receiving portion. In this case, the heating coil can be easily supported by the inserting portion of the center pole which tightens, and the axis of the heating coil is further prevented from becoming bent on the distal end side located forwardly of the weld portion.

In the method for manufacturing a glow plug in accordance with the first and second aspects of the invention, the inserting portion of the center pole may be provided with chamfering at its edge portion. In addition, the inserting portion may have a first tapered surface which becomes smaller in diameter toward its distal end and forms at least a portion of the overlapping portion and a second tapered surface which becomes smaller in diameter toward its distal end continuously from the first tapered surface and is smaller in diameter than the inside diameter of the insertion receiving portion. In this case, in the first step, the operation of inserting the inserting portion of the center pole into the insertion receiving portion of the heating coil can be easily carried out, with the result that the operating efficiency can be improved.

In the method for manufacturing a glow plug in accordance with the first and second aspects of the invention, a large-diameter portion which is contiguous to a rear end of the inserting portion and has an outside diameter larger than a total of an inside diameter of the insertion receiving portion and a wire diameter of the heating coil is preferably formed in the center pole. In this case, in the first step, as the inserting portion of the center pole is inserted into the insertion receiving portion of the heating coil, and the distal end face of the large-diameter portion is abutted against the rear end of the heating coil to stop, the operation of providing the overlapping portion of a fixed length can be easily carried out. As a result, the operating efficiency can be improved.

The glow plug of the invention can be obtained by the manufacturing method in accordance with the invention. Namely, the flow plug of the invention is a glow plug comprising: a cylindrical metal shell extending in an axial direction; a heating tube which has a cylindrical shape extending in the axial direction, has its distal end closed, and is fixed within the metal shell with its distal end projecting from a distal end of the metal shell; a center pole which has a rod shape extending in the axial direction, with its distal end located within the heating tube and its rear end projecting from a rear end of the metal shell; and a heating coil which has a helical shape extending in the axial direction, with its distal end joined to the distal end of the heating tube within the heating tube and its rear end joined to the distal end of the center pole,

wherein an inserting portion formed at the distal end of the center pole is inserted into an insertion receiving portion formed at a rear end of the heating coil, to thereby form an overlapping portion where the inserting portion and the insertion receiving portion abut against each other and overlap in a radial direction, the inserting portion and the insertion receiving portion are welded together at the overlapping portion so as to form a weld portion, and a ½ turn or more of winding of the heating coil in a state of being not welded to the inserting portion is present between a distal end position of the weld portion and a distal end position of the overlapping portion.

For the above-described reason, the glow plug of the invention having the above-described construction can be made smaller in diameter, so that it is possible to increase the temperature rise speed and cope with a reduction in the diameter of the glow hole due to the demand for a more compact and lightweight diesel engine.

In the invention, the center pole may be formed of a plurality of members. In the case where the center pole is formed of a plurality of members, the inserting portion is formed at the distal end of the distal end-side member. In the case where the center pole is formed of a single member, the inserting portion is formed at a distal end of that member.

The electrodes are not limited to two or even-numbered pieces insofar as they are capable of sandwiching the overlapping portion in the radial direction.

### BRIEF DESCRIPTION OF THE DRAWINGS

FIG. 1 is a schematic diagram illustrating first and second steps in accordance with a method for manufacturing a glow plug 1A of Example 1;

FIG. 2 is an enlarged schematic diagram of essential portions, illustrating the first and second steps in accordance with the method for manufacturing the glow plug 1A of Example 1;

FIG. 3 is a cross-sectional view, taken in the direction of arrows along intermediate body—intermediate body of FIG. 1, in accordance with the method for manufacturing the glow plug 1A of Example 1;

FIG. 4 is a schematic diagram illustrating the first and second steps in accordance with a method for manufacturing a glow plug 1B of Example 2;

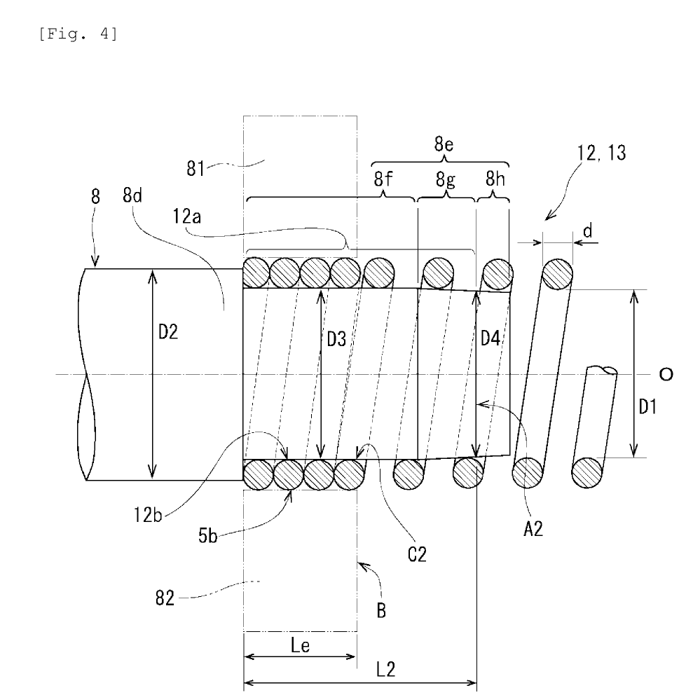

FIG. 5 is a cross-sectional view of a glow plug in accordance with a conventional method for manufacturing a glow plug;

FIG. 6 is a schematic diagram illustrating first and second steps in accordance with the conventional method for manufacturing a glow plug; and

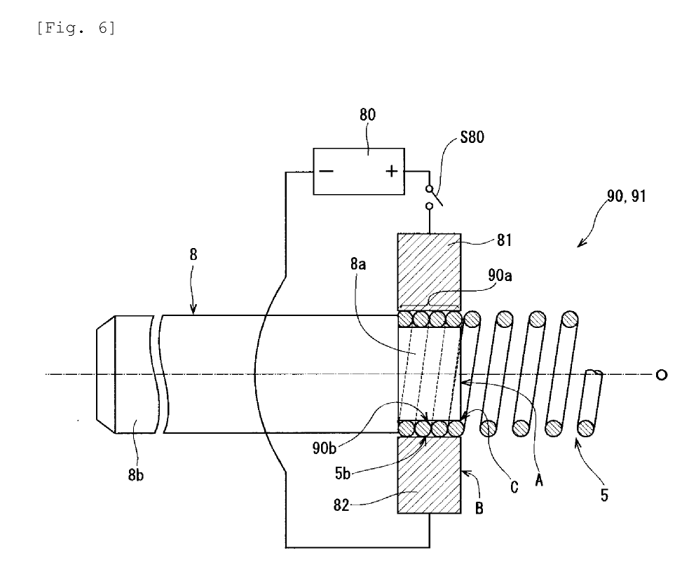

FIG. 7 is an enlarged schematic diagram of essential portions, illustrating the first and second steps in accordance with the conventional method for manufacturing a glow plug.

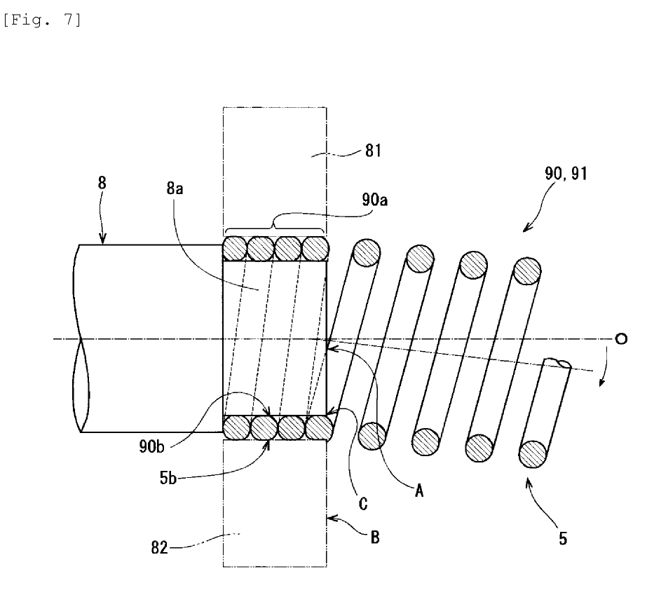

### DESCRIPTION OF REFERENCE NUMERALS AND SIGNS

1A, 1A′, 1B, 100: glow plugs
3: metal shell
4: heating tube
4a: distal end of the heating tube
5: heating coil
5a: distal end of the heating coil
5b: insertion receiving portion of the heating coil
6: center pole
8: first center pole
9: second center pole
10, 12, 90: first glow plug intermediate body
11, 13, 91: second glow plug intermediate body
8a, 8c, 8e: inserting portions of the center poles
8d: large-diameter portion
8f: cylindrical surface
8g: first tapered surface
8h: second tapered surface
10a, 12a, 90a: overlapping portions
10b, 12b, 90b: weld portions
80: power supply
S80: switch
81, 82: electrodes
A, A1, A2: distal end positions of the overlapping portions
B: distal end face of the electrode
C, C1, C2: distal end positions of the weld portions
D1: inside diameter of the insertion receiving portion
D2: outside diameter of the large-diameter portion
D3: outside diameter of the inserting portion
D4: outside diameter of the distal end of the first tapered surface
d: wire diameter of the heating coil

### BEST MODE FOR CARRYING OUT THE INVENTION

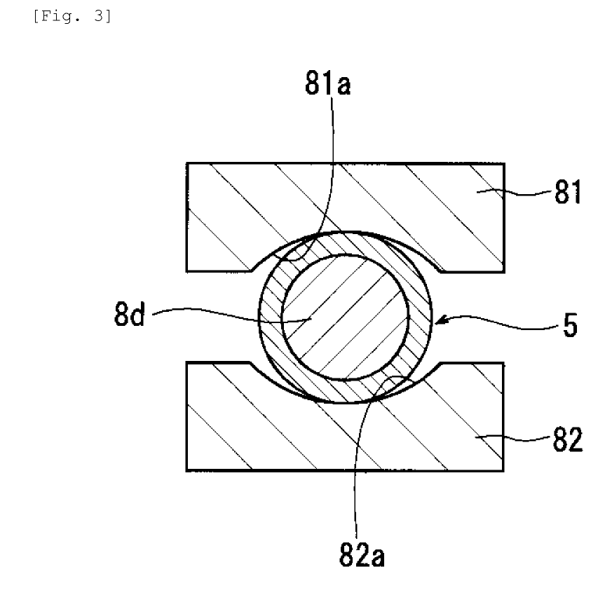

Referring now to the drawings, a description will be given of first and second embodiments of the invention. It should be noted that, in the respective drawings excluding FIG. 3, the right side is a distal end side and the left side is a rear end side.

### Example 1

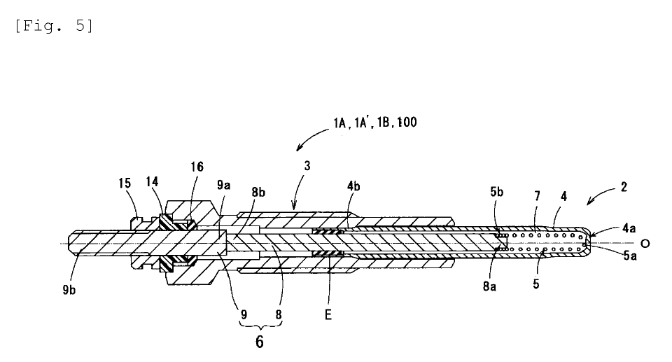

As shown in FIG. 5, a glow plug 1A in accordance with the manufacturing method of Example 1 is substantially similar to the conventional glow plug 100. The same reference numerals will be used for the construction identical to the conventional mechanical construction shown in FIG. 5, and a description thereof will be omitted.

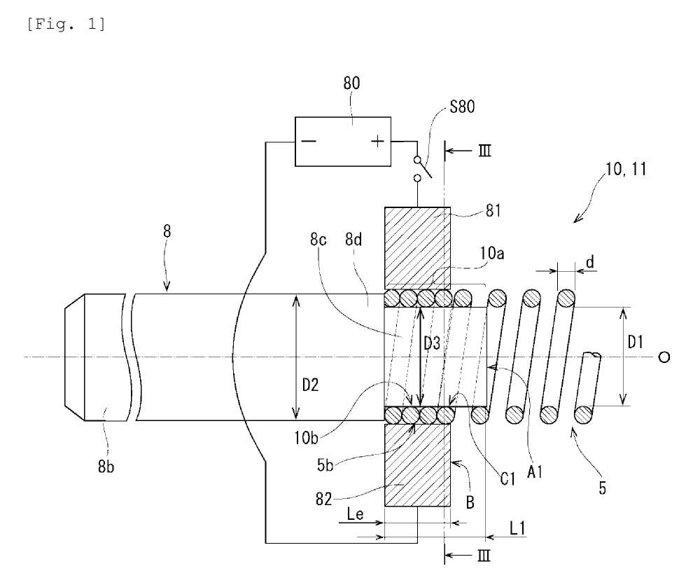

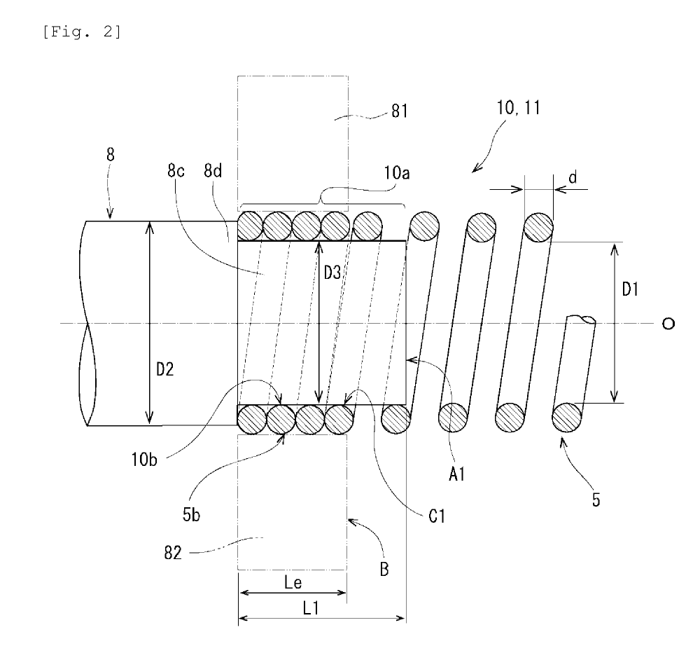

This glow plug 1A is manufactured as follows. First, a heating coil 5 is prepared, as shown in FIGS. 1 and 2. The material of the heating coil 5 is a Co—Ni—Fe alloy, an Fe alloy, an Ni alloy, or the like. In addition, the inside diameter D1 of the heating coil 5 is 2.6 mm, and its wire diameter d is 0.25 mm.

In addition, a first center pole 8 is prepared. The first center pole 8 is a rod-like member extending in the direction of an axis O and is a distal end-side member among a plurality of members making up a center pole 6. The material of the first center pole 8 is, for example, SCM435, and a cylindrical inserting portion 8c is formed at a distal end of the first center pole 8, while a large-diameter portion 8d is formed in such a manner as to be contiguous to the rear end of the inserting portion. The outside diameter D3 of the inserting portion 8c is 2.65 mm which is slightly larger than the inside diameter D1 of the heating coil 5, and the outside diameter D2 of the large-diameter portion 8d is 2.9 mm which is larger than the total of the inside diameter D1 of the heating coil 5 and the wire diameter d of the heating coil 5. In addition, the length L1 in the direction of the axis O between a distal end position A1 of the inserting portion 8c and a distal end face of the large-diameter portion 8d is 1.75 mm.

Next, as the first step, the inserting portion 8c of the first center pole 8 is inserted into an insertion receiving portion 5b of the heating coil 5, to thereby provide an overlapping portion 10a where the inserting portion 8c of the first center pole 8 and the insertion receiving portion 5b of the heating coil 5 abut against each other and overlap in the radial direction. At this juncture, the arrangement provided is such that as the rear end of the heating coil 5 abuts against the distal end face of the large-diameter portion 8d and stops, the overlapping portion 10a of a fixed length is provided. Namely, the length of the overlapping portion 10a in the direction of the axis O is always equal to the length L1 in the direction of the axis O between the distal end position A1 of the inserting portion 8c and the distal end face of the large-diameter portion 8d. Further, because the outside diameter D3 of the inserting portion 8c is slightly larger than the inside diameter D1 of the insertion receiving portion 5b, the heating coil 5 is in a state in which it tightens the inserting portion 8c. A first glow plug intermediate body 10 is thus obtained.

Then, as the second step, a portion of the overlapping portion 10a of the first glow plug intermediate body 10 obtained in the first step is sandwiched by two electrodes 81 and 82 which oppose each other. Here, the electrodes 81 and 82 are similar to the conventional ones and their length Le in the direction of the axis O is 1.25 mm. On the other hand, the length L1 in the direction of the axis O between the distal end position A1 of the inserting portion 8c and the distal end face of the large-diameter portion 8d is extended and set to 1.75 mm although it was substantially identical to the length Le of the electrodes and 82 in the direction of the axis O. For this reason, the setting provided is such that the heating coil 5 is present by a length of 0.5 mm (about one turn) between the distal end face B of each of the electrodes 81 and 82 and the distal end position A1 of the overlapping portion 10a.

Next, a predetermined load is applied perpendicularly to a portion of the overlapping portion 10a through the electrodes and 82. Here, as shown in FIG. 3, semicylindrical concave portions 81a and 82a are respectively provided at portions of the electrodes 81 and 82 which come into contact with the insertion receiving portion 5b of the heating coil 5. For this reason, when the electrodes 81 and 82 apply a load to the overlapping portion 10a, the electrodes 81 and 82 are capable of effecting centering with respect to the insertion receiving portion 5b of the heating coil 5, so that the load can be easily applied to the overlapping portion 10a. The electrodes 81 and 82 are connected to a power supply 80 through a switch S80, and as a current is applied across the electrodes 81 and 82 by turning on the switch S80, the inserting portion 8c of the first center pole 8 and the insertion receiving portion 5b of the heating coil 5 are welded together. As a result, as shown in FIGS. 1 and 2, a weld portion 10b is formed such that about one turn of winding (a length of 0.5 mm) of the heating coil 5 in a state of being not welded to the inserting portion 8c of the first center pole 8 is present between a distal end position C1 of the weld portion 10b and the distal end position A1 of the overlapping portion 10a. A second glow plug intermediate body 11 in which the first center pole 8 and the heating coil 5 are joined is thus obtained.

Here, with respect to the second glow plug intermediate bodies 11 fabricated in the above-described step, an evaluation was made as to whether or not bending occurred in the axis of the heating coil 5 on the distal end side located forwardly of the weld portion 10b. Specifically, in the case where the axis of the heating coil 5 was inclined 3° or more with respect to the axis O on the distal end side located forwardly of the weld portion 10b, an evaluation was made that bending occurred. As a result, no bending of the axis of the heating coil 5 was found to have occurred in all of 10 second glow plug intermediate bodies 11.

On the other hand, by setting the length L1 in the direction of the axis O between the distal end position A1 of the inserting portion 8c and the distal end face of the large-diameter portion 8d to the same value of 1.25 mm as the length Le of the electrodes and 82 in the direction of the axis O, second glow plug intermediate bodies (not shown) of Comparative Example 1 were fabricated in a similar step. Then, with respect to the second glow plug intermediate bodies of Comparative Example 1 as well, an evaluation was made as to whether or not bending occurred in the axis of the heating coil 5 on the distal end side located forwardly of the weld portion 10b. As a result, bending of the axis of the heating coil 5 was found to have occurred in seven bodies of 10 second glow plug intermediate bodies of Comparative Example 1.

The second glow plug intermediate bodies 11 of Example 1 and the second glow plug intermediate bodies of Comparative Example 1 thus fabricated are each assembled to a metal shell 3 and the like in the same way as the conventional one shown in FIG. 5, and are respectively formed into the glow plugs 1A of Example 1 and glow plugs 1A′ of Comparative Example. Since the assembling procedure and the like are also similar to the conventional one, a description thereof will be omitted. The glow plugs 1A and 1A′ thus obtained are used in diesel engines.

Here, in terms of the perspective of production control, in the method for manufacturing the glow plug 1A of Example 1, the respective electrodes 81 and 82 and the overlapping portion 10a are specified in the above-described first and second steps. Further, about one turn of winding of the heating coil 5 is present between the distal end face B of each of the electrodes 81 and 82 and the distal end position A1 of the overlapping portion 10a.

Here, in terms of the perspective of the manufactured end product, in the method for manufacturing the glow plug 1A of Example 1, the overlapping portion 10a and the weld portion 10b are specified in the above-described first and second steps. Further, about one turn of winding of the heating coil 5 in a state of being not welded to the inserting portion 8c is present between the distal end position C1 of the weld portion 10b and the distal end position A1 of the overlapping portion 10a.

For this reason, in the case of the second glow plug intermediate body 11 obtained by the manufacturing method according to Example 1, even if the deformation of the heating coil 5 becomes large at the distal end position C1 of the weld portion 10b, since the heating coil 5, which is not welded and has a ½ turn or more of winding from the distal end position C1 of the weld portion 10b, is supported by the inserting portion 8c of the first center pole 8, the axis of the heating coil 5 is prevented from becoming bent on the distal end side located forwardly of the distal end position C1 of the weld portion 10b.

For this reason, in the case of the glow plug 1A obtained by this second glow plug intermediate body 11, even if the current applied across the electrodes 81 and 82 is increased to enhance the welding strength between the inserting portion 8c of the first center pole 8 and the insertion receiving portion 5b of the heating coil 5 to thereby increase the amount of weld penetration of the heating coil 5, the heating coil 5 is difficult to come into contact with the inner cylindrical surface of the heating tube 4. Hence, a defect in quality such as a short-circuit fault and variations in performance when applying current is made difficult to occur.

Therefore, according to the method for manufacturing the glow plug 1A of Example 1, it is possible to suppress a defect in quality such as a short-circuit fault and variations in the performance when applying current.

For this reason, the glow plug 1A which is obtained by this method for manufacturing the glow plug 1A can be made smaller in diameter, so that it is possible to increase the temperature rise speed and cope with a reduction in the diameter of the glow hole due to the demand for a more compact and lightweight diesel engine.

In contrast, with the second glow plug intermediate bodies of Comparative Example 1, since the bending of the axis of the heating coil 5 occurred with a probability of 7/10. Therefore, in the case of the glow plug 1A′ obtained from the second glow plug intermediate body of Comparative Example 1, a defect in quality such as a short-circuit fault and variations in the performance when applying current occurs with a certain measure of probability, so that it is not preferable.

In addition, in the method for manufacturing the glow plug 1A of Example 1, the electrodes 81 and 82 are disposed such that three or more turns of winding of the heating coil 5 will not be present between the distal end face B of each of the electrodes 81 and 82 and the distal end position A1 of the overlapping portion 10a. To put it differently from the perspective of the fabricated end product, in the method for manufacturing the glow plug 1A of Example 1, the weld portion 10b is formed such that with three or more turns of winding of the heating coil 5 in a state of being not welded to the inserting portion 8c of the first center pole 8 will not be present between the distal end position C1 of the weld portion 10b and the distal end position A1 of the overlapping portion 10a. For this reason, in the method for manufacturing the glow plug 1A of Example 1, since the nonwelded portion of the inserting portion 8c of the first center pole 8 is not made inordinately long, the resistance value is made difficult to vary while demonstrating the effect of the invention, so that variations in the performance when applying current can also be made small.

Furthermore, in this method for manufacturing the glow plug 1A of Example 1, because the outside diameter D3 of the inserting portion 8c in the overlapping portion 10a is larger than the inside diameter D1 of the insertion receiving portion 5b, the heating coil 5 can be easily supported by the inserting portion 8c of the first center pole 8 which tightens. Thus, the axis of the heating coil 5 is further prevented from becoming bent on the distal end side located forwardly of the weld portion 10b.

In addition, in this method for manufacturing the glow plug 1A of Example 1, the large-diameter portion 8d, which is contiguous to the rear end of the inserting portion 8c and has the outside diameter D2 larger than the total of the inside diameter D1 of the insertion receiving portion 5b and the wire diameter d of the heating coil 5, is formed in the first center pole 8. For this reason, in the first step, as the inserting portion 8c of the first center pole 8 is inserted into the insertion receiving portion 5b of the heating coil 5, and the distal end face of the large-diameter portion 8d is abutted against the rear end of the heating coil 5 to stop, the operation of providing the overlapping portion 10a of a fixed length can be easily carried out. As a result, the operating efficiency can be improved.

### Example 2

In the method for manufacturing a glow plug 1B of Example 2, instead of the inserting portion 8c of the first center pole 8 described in the method for manufacturing the glow plug 1A of Example 1, an inserting portion 8e is adopted which has a cylindrical surface 8f, a first tapered surface 8g contiguous to the distal end side of the cylindrical surface 8f, and a second tapered surface 8h contiguous to the distal end side of the first tapered surface 8g. The other arrangements are similar to those of the method for manufacturing the glow plug 1A of Example 1, so that a description thereof will be omitted.

The first tapered surface 8g becomes smaller in diameter toward its distal end and forms at least a portion of an overlapping portion 12a. Since the outside diameter D4 of a distal end of the first tapered surface 8g is set equal to the inside diameter D1 of the insertion receiving portion 5b, a distal end position A2 of the overlapping portion 12a is the distal end of the first tapered surface 8g. For this reason, when the inserting portion 8e of the first center pole 8 is inserted into the insertion receiving portion 5b of the heating coil 5, the first tapered surface 8g acts so as to guide the inserting portion 8e into the heating coil 5. In addition, the length L2 in the direction of the axis O between the distal end position A2 of the overlapping portion 12a and the distal end face of the large-diameter portion 8d is 2.25 mm.

The second tapered surface 8h becomes smaller in diameter toward its distal end continuously from the first tapered surface 8g and is smaller in diameter than the inside diameter D1 of the insertion receiving portion 5b. For this reason, the operation of inserting the foremost end of the inserting portion 8e of the first center pole 8 into the insertion receiving portion 5b of the heating coil 5 is further facilitated.

In the method for manufacturing the glow plug 1B of Example 2 having such an inserting portion 8e of the first center pole 8, a first glow plug intermediate body 12 provided with the overlapping portion 12a is obtained in the first step.

Then, in the second step, a portion of the overlapping portion 12a of the first glow plug intermediate body 12 obtained in the first step is sandwiched by the two electrodes 81 and which oppose each other. Here, the electrodes 81 and 82 are similar to the conventional ones and their length Le in the direction of the axis O is 1.25 mm. On the other hand, the length L2 in the direction of the axis O between the distal end position A2 of the overlapping portion 12a and the distal end face of the large-diameter portion 8d is further extended and set to 2.25 mm although it was substantially identical to the length Le of the electrodes 81 and 82 in the direction of the axis O. For this reason, the setting provided is such that the heating coil 5 is present by a length of 1.0 mm (about two turns) between the distal end face B of each of the electrodes 81 and 82 and the distal end position A2 of the overlapping portion 12a.

Next, a portion of the overlapping portion 12a is welded by means of the electrodes 81 and 82 in the same way as in the method for manufacturing the glow plug 1A of Example 1. As a result, a weld portion 12b is formed such that about two turns of winding (a length of 1.0 mm) of the heating coil 5 in a state of being not welded to the inserting portion 8e of the first center pole 8 are present between a distal end position C2 of the weld portion 12b and the distal end position A2 of the overlapping portion 12a. A second glow plug intermediate body in which the first center pole 8 and the heating coil 5 are joined is thus obtained.

This second glow plug intermediate body 13 is also formed into the glow plug 1B in the same way as the second glow plug intermediate body 11 of Example 1.

Here, in terms of the perspective of production control, in the method for manufacturing the glow plug 1B of Example 2, the respective electrodes 81 and 82 and the overlapping portion 12a are specified in the above-described first and second steps. Further, about two turns of winding of the heating coil 5 are present between the distal end face B of each of the electrodes 81 and 82 and the distal end position A2 of the overlapping portion 12a.

Here, in terms of the perspective of the manufactured end product, in the method for manufacturing the glow plug 1B of Example 2, the overlapping portion 12a and the weld portion 12b are specified in the above-described first and second steps. Further, about two turns of winding of the heating coil 5 in a state of being not welded to the inserting portion 8e are present between the distal end position C2 of the weld portion 12b and the distal end position A2 of the overlapping portion 12a.

For this reason, also in the case of the second glow plug intermediate body 13 obtained by the manufacturing method according to Example 2, the axis of the heating coil 5 is prevented from becoming bent on the distal end side located forwardly of the weld portion 12b for the same reason as that for the second glow plug intermediate body 11 obtained by the manufacturing method according to Example 1.

For this reason, also in the case of the glow plug 1B obtained by this second glow plug intermediate body 13, a defect in quality such as a short-circuit fault and variations in the performance when applying current is made difficult to occur.

Therefore, according to the method for manufacturing the glow plug 1B of Example 2 as well, it is possible to suppress a defect in quality such as a short-circuit fault and variations in the performance when applying current.

In addition, in this method for manufacturing the glow plug 1B, the inserting portion 8e of the first center pole 8 has, in addition to the cylindrical surface 8f, the aforementioned first tapered surface 8g and second tapered surface 8h. For this reason, in the first step, the operation of inserting the inserting portion 8e of the first center pole 8 into the insertion receiving portion 5b of the heating coil 5 can be easily carried out. As a result, the operating efficiency can be improved.

Although the invention has been described above on the basis of Examples 1 and 2, the invention is not limited to the above-described Examples 1 and 2, and it goes without saying that the invention is applicable by being modified appropriately within the scope that it does not depart from its gist.

For example, the heating coil is not limited to the case where it is constituted by one member as in the heating coil 5, and the heating coil may be constituted by a plurality of materials having different temperature coefficients of resistance (one having a self-controlling function consisting of a so-called control coil and heating coil).

In addition, the inside diameter D1 of the heating coil 5 described in Examples 1 and 2 suffices if the inside diameter D1 is provided at the insertion receiving portion 5b of the heating coil 5, and the inside diameter at other than the insertion receiving portion 5b may be larger than D1.

### INDUSTRIAL APPLICABILITY

The invention is applicable to a glow plug.

1. A method for manufacturing a glow plug including
a cylindrical metal shell extending in an axial direction,
a heating tube which has a cylindrical shape extending in the axial direction, has its distal end closed, and is fixed within the metal shell with its distal end projecting from a distal end of the metal shell,
a center pole which has a rod shape extending in the axial direction, with its distal end located within the heating tube and its rear end projecting from a rear end of the metal shell, and
a heating coil which has a helical shape extending in the axial direction, with its distal end joined to the distal end of the heating tube within the heating tube and its rear end joined to the distal end of the center pole, comprising:
a first step of inserting an inserting portion formed at the distal end of the center pole into an insertion receiving portion formed at a rear end of the heating coil, to thereby provide an overlapping portion where the inserting portion and the insertion receiving portion abut against each other and overlap in a radial direction; and
a second step of applying a current across a plurality of electrodes while sandwiching at least a portion of the overlapping portion by the electrodes in the radial direction to thereby weld the inserting portion and the insertion receiving portion so as to form a weld portion,
wherein the weld portion is formed such that a ½ turn or more of winding of the heating coil in a state of being not welded to the inserting portion is present between a distal end position of the weld portion and a distal end position of the overlapping portion.

2. The method for manufacturing a glow plug according to claim 1, wherein the weld portion is formed such that three or more turns of winding of the heating coil in a state of being not welded to the inserting portion are not present between the distal end position of the weld portion and the distal end position of the overlapping portion.

3. A method for manufacturing a glow plug including
a cylindrical metal shell extending in an axial direction,
a heating tube which has a cylindrical shape extending in the axial direction, has its distal end closed, and is fixed within the metal shell with its distal end projecting from a distal end of the metal shell,
a center pole which has a rod shape extending in the axial direction, with its distal end located within the heating tube and its rear end projecting from a rear end of the metal shell, and
a heating coil which has a helical shape extending in the axial direction, with its distal end joined to the distal end of the heating tube within the heating tube and its rear end joined to the distal end of the center pole, comprising:
a first step of inserting an inserting portion formed at the distal end of the center pole into an insertion receiving portion formed at a rear end of the heating coil, to thereby provide an overlapping portion where the inserting portion and the insertion receiving portion abut against each other and overlap in a radial direction; and
a second step of applying a current across a plurality of electrodes while sandwiching the overlapping portion by the electrodes in the radial direction to thereby weld the inserting portion and the insertion receiving portion so as to form a weld portion,
wherein the electrodes are disposed such that a ½ turn or more of winding of the heating coil is present between a distal end face of each of the electrodes and a distal end position of the overlapping portion.

4. The method for manufacturing a glow plug according to claim 3, wherein the electrodes are disposed such that three or more turns of winding of the heating coil are not present between the distal end face of each of the electrodes and the distal end position of the overlapping portion.

5. The method for manufacturing a glow plug according to claim 1, wherein an outside diameter of the inserting portion at the overlapping portion is larger than an inside diameter of the insertion receiving portion.

6. The method for manufacturing a glow plug according to claim 5, wherein the inserting portion has a first tapered surface which becomes smaller in diameter toward its distal end and forms at least a portion of the overlapping portion and a second tapered surface which becomes smaller in diameter toward its distal end continuously from the first tapered surface and is smaller in diameter than the inside diameter of the insertion receiving portion.

7. The method for manufacturing a glow plug according to claim 5, wherein a large-diameter portion which is contiguous to a rear end of the inserting portion and has an outside diameter larger than a total of an inside diameter of the insertion receiving portion and a wire diameter of the heating coil is formed in the center pole.

8. A glow plug comprising:
a cylindrical metal shell extending in an axial direction;
a heating tube which has a cylindrical shape extending in the axial direction, has its distal end closed, and is fixed within the metal shell with its distal end projecting from a distal end of the metal shell;
a center pole which has a rod shape extending in the axial direction, with its distal end located within the heating tube and its rear end projecting from a rear end of the metal shell; and
a heating coil which has a helical shape extending in the axial direction, with its distal end joined to the distal end of the heating tube within the heating tube and its rear end joined to the distal end of the center pole,
wherein an inserting portion formed at the distal end of the center pole is inserted into an insertion receiving portion formed at a rear end of the heating coil, to thereby form an overlapping portion where the inserting portion and the insertion receiving portion abut against each other and overlap in a radial direction, the inserting portion and the insertion receiving portion are welded together at the overlapping portion so as to form a weld portion, and a ½ turn or more of winding of the heating coil in a state of being not welded to the inserting portion is present between a distal end position of the weld portion and a distal end position of the overlapping portion.

9. The method for manufacturing a glow plug according to claim 2, wherein an outside diameter of the inserting portion at the overlapping portion is larger than an inside diameter of the insertion receiving portion.

10. The method for manufacturing a glow plug according to claim 3, wherein an outside diameter of the inserting portion at the overlapping portion is larger than an inside diameter of the insertion receiving portion.

11. The method for manufacturing a glow plug according to claim 4, wherein an outside diameter of the inserting portion at the overlapping portion is larger than an inside diameter of the insertion receiving portion.

12. The method for manufacturing a glow plug according to claim 9, wherein the inserting portion has a first tapered surface which becomes smaller in diameter toward its distal end and forms at least a portion of the overlapping portion and a second tapered surface which becomes smaller in diameter toward its distal end continuously from the first tapered surface and is smaller in diameter than the inside diameter of the insertion receiving portion.

13. The method for manufacturing a glow plug according to claim 10, wherein the inserting portion has a first tapered surface which becomes smaller in diameter toward its distal end and forms at least a portion of the overlapping portion and a second tapered surface which becomes smaller in diameter toward its distal end continuously from the first tapered surface and is smaller in diameter than the inside diameter of the insertion receiving portion.

14. The method for manufacturing a glow plug according to claim 11, wherein the inserting portion has a first tapered surface which becomes smaller in diameter toward its distal end and forms at least a portion of the overlapping portion and a second tapered surface which becomes smaller in diameter toward its distal end continuously from the first tapered surface and is smaller in diameter than the inside diameter of the insertion receiving portion.

15. The method for manufacturing a glow plug according to claim 9, wherein a large-diameter portion which is contiguous to a rear end of the inserting portion and has an outside diameter larger than a total of an inside diameter of the insertion receiving portion and a wire diameter of the heating coil is formed in the center pole.

16. The method for manufacturing a glow plug according to claim 10, wherein a large-diameter portion which is contiguous to a rear end of the inserting portion and has an outside diameter larger than a total of an inside diameter of the insertion receiving portion and a wire diameter of the heating coil is formed in the center pole.

17. The method for manufacturing a glow plug according to claim 11, wherein a large-diameter portion which is contiguous to a rear end of the inserting portion and has an outside diameter larger than a total of an inside diameter of the insertion receiving portion and a wire diameter of the heating coil is formed in the center pole.

18. The method for manufacturing a glow plug according to claim 6, wherein a large-diameter portion which is contiguous to a rear end of the inserting portion and has an outside diameter larger than a total of an inside diameter of the insertion receiving portion and a wire diameter of the heating coil is formed in the center pole.

19. The method for manufacturing a glow plug according to claim 12, wherein a large-diameter portion which is contiguous to a rear end of the inserting portion and has an outside diameter larger than a total of an inside diameter of the insertion receiving portion and a wire diameter of the heating coil is formed in the center pole.

20. The method for manufacturing a glow plug according to claim 13, wherein a large-diameter portion which is contiguous to a rear end of the inserting portion and has an outside diameter larger than a total of an inside diameter of the insertion receiving portion and a wire diameter of the heating coil is formed in the center pole.

21. The method for manufacturing a glow plug according to claim 14, wherein a large-diameter portion which is contiguous to a rear end of the inserting portion and has an outside diameter larger than a total of an inside diameter of the insertion receiving portion and a wire diameter of the heating coil is formed in the center pole.
